(19) United States
(12) Patent Application Publication
(10) Pub. No.: US 2011/0301806 A1
(43) Pub. Date: Dec. 8, 2011

(54) Method and System For Intelligent Fuel Monitoring and Real Time Planning

(76) Inventors: Daniel John Messier, Albany, NY (US); Patricia Denise Mackenzie, Clifton Park, NY (US); Joseph James Salvo, Schenectdady, NY (US); Bouchra Bouqata, Niskayuna, NY (US)

(21) Appl. No.: 12/792,882

(22) Filed: Jun. 3, 2010

(51) Int. Cl. G01C 21/36; G06F 7/00

(52) U.S. Cl. 701/33; 701/29

(57) ABSTRACT

A method and system are provided for intelligent fuel monitoring and real-time dynamic route planning for a vehicle. The system includes one or more sensor devices monitoring a vehicle status; and a processing system coupled to the one or more sensor devices, the processing system having a memory and a processor, wherein the processor is programmed to: receive a plurality of data such as: vehicle status sensor data, points of interest data, environmental data, user data, route data. The processor then learns driver behavior from the plurality of data that influences selection of driving routes; processes the plurality of data for a current route; determines an optimal route based on the plurality of data processed for the current route and the learned driver behavior; and outputs the optimal route.

### FIELD OF THE INVENTION

The subject matter disclosed herein relates to the field of commercial vehicle management devices and specifically to an improved system, method, and computer-readable instructions for intelligent fuel monitoring and real time route planning for a vehicle telematics system.

### BACKGROUND OF THE INVENTION

In the commercial trucking industry, it is desirable to track data associated with vehicle travel, including fuel consumption for intelligent route planning that includes fuel stops. Off-line and pre-trip planning systems provide route planning that includes fuel stops. As these systems are designed for pre-trip planning, such systems cannot provide in-trip adjustment and or take into consideration other dynamic factors such as driver behavior, driver preference, weather, and traffic.

U.S. Pat. No. 6,714,857 provides for remote monitoring of a vehicle and method of determining vehicle mileage, jurisdiction crossing, and fuel consumption, including a positioning system for generating the present position information of the vehicle. However, as this system only monitors the vehicle, it does not provide dynamic route planning.

There is a need for dynamic analysis and rerouting to reduce fuel costs and provide for real-time planning.

### BRIEF DESCRIPTION OF THE INVENTION

In one aspect thereof, the present invention provides a method of intelligent fuel monitoring and real-time dynamic route planning for a vehicle. An embodiment of the invention includes the operations of: receive input from local sensors as to vehicle status (fuel level, vehicle location, etc.); retrieve data regarding fuel stop locations and environmental data that affects driving routes (e.g., weather/traffic); consider any user inputs as to preferences or learned driver behavior related to fueling and routes; process the data in conjunction with current routing information; determine an optimal route; output the results.

In another aspect thereof, the present invention provides for a system for intelligent fuel monitoring and real-time dynamic route planning for a vehicle. The system comprises an on-board computing device having input devices (user input, sensors, and receivers), output devices (display, transmitters), communication devices (wireless communications), processor, and memory. The on-board computing device receives input from local sensors as to vehicle status (fuel level, vehicle location, etc.); retrieves data (local or remote) regarding fuel stop locations and environmental data that affects driving routes (e.g., weather/traffic); considers any user inputs as to preferences or learned driver behavior related to fueling and routes; processes via the processor the data in conjunction with current routing information; determines an optimal route; outputs the results—the optimal route.

In another aspect thereof, the present invention provides a computer readable medium for intelligent fuel monitoring and real-time dynamic route planning for a vehicle, including code devices for: receiving input from local sensors as to vehicle status; retrieving data regarding fuel stop locations and environmental data that affects driving routes; considering any user inputs as to preferences or learned driver behavior related to fueling and routes; processing the data in conjunction with current routing information; determining an optimal route; outputting the results.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram of a system for intelligent fuel monitoring and real-time dynamic route planning for a vehicle in which an embodiment of the invention may be implemented.

FIG. 2 shows a simplified flow chart according to an embodiment of the present invention.

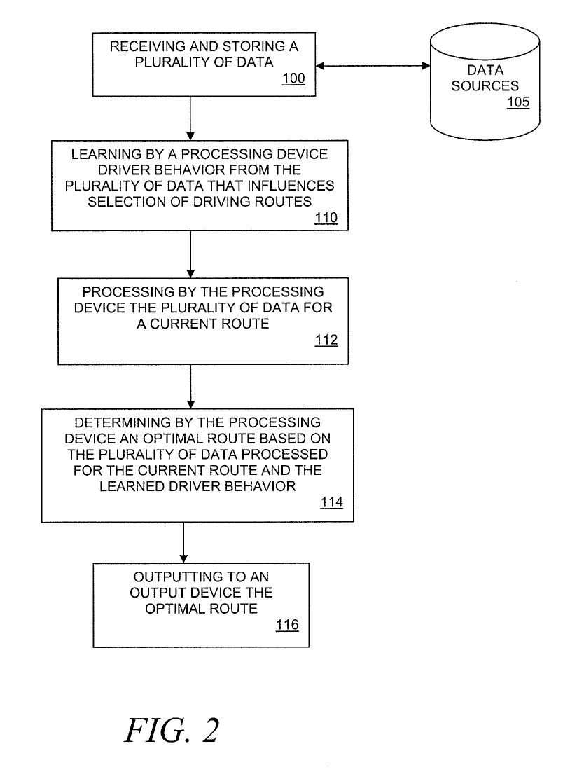

### DETAILED DESCRIPTION OF THE INVENTION

Aspects of the present invention offer an improved method and system for intelligent fuel monitoring and real-time dynamic route planning for a vehicle. In conjunction with an on-board processing system such as a vehicle telematics system, including on-board processing, sensor inputs and connectivity to data sources, an embodiment includes code devices, such as an intelligent software agent, running locally on the on-board system that monitors the fuel level of the vehicle along with driver behavior in order to make intelligent decisions about when and where refueling stops are made, so as to optimize the tradeoff between arrival time at destination and money spent on fuel.

The inputs to the system may include, for example, the current fuel level, current fuel consumption, planned route, planned time of arrival or arrival time window and learned driver preferences.

The system has the ability to poll or, when relevant events occur, receive pushes from or continually monitor one or more external systems or data sources for fuel station locations and pricing as well as weather and traffic conditions. The driving conditions (such as weather conditions, traffic, etc.) can influence the arrival time and fuel consumption.

The system also has the ability to deduce driver behavior, such as speed, from the specified inputs along with other sensors. Since driving conditions and driver's behavior are dynamic, the on-board system processes these inputs to determine where to refuel.

Using these inputs and capabilities, the output of the system is a dynamic optimal route to the destination, including fuel stops. This route is optimized to meet arrival commitments as well as minimize the amount of fuel spent, or capital spent on fuel, while taking into consideration the actual information about the route and the driving conditions.

A feature of this system is the on-board processing device in the vehicle. This system has access to a variety of sensors (for sensing proximal environmental and status data for the vehicle and its environment) and communication devices (for retrieving remote and/or external data). The system outputs help the driver make informed decisions about when to purchase fuel and how to adjust routes.

An advantage of the system is the ability to dynamically adjust routes during the trip based on dynamic data such as fuel consumption, fuel level, driver behavior, driver preference and external data such as traffic and weather.

These new routes can be communicated to the driver via a variety of output devices such as an audio, visual or textual interface that is placed inside of the vehicle, or to a personal communication device (cell phone, PDA) on the driver's person.

The system is also capable of learning driver preferences. For example, if a driver continually acts to keep a tank half full in winter, the system would learn that new threshold point and adjust accordingly. Similarly, by learning how a driver responds to a given recommendation, say to fuel at a station with a convenience store versus a gas-only station, the system would learn what type of station to recommend to the driver.

The system is unique in the sense that it can analyze dynamic information as the vehicle is moving and the driving conditions change. It does this by perceiving the information it receives from different local sensors on the vehicle and from remote sources like the backend system. The system filters the information based on its relevance to the actual situation and the goal of the conditional optimization of fuel consumption, fuel price, learned driver preference, and overall route length while arriving on time or within an arrival time window to the destination. Then it determines based on those relevant inputs an optimal trip plan, indicating when and where to refuel.

Moreover, since time-sensitive decisions are made locally, the system allows for the driver to alter driving behavior and conditions at the appropriate time.

Advantages of the system are numerous. For example, the system provides on-board analysis of fuel consumption and level, along with driver behavior and external information like traffic and weather. It also provides for integration allowing for updated route planning, rather than route planning done pre-trip. Moreover, integration with scheduled time of arrival or arrival time window is provided. The system uses the schedule time of arrival or arrival time window (as indicated by the driver or trip planner) to determine the time-feasibility of fuel stops. It also allows for driver behavior analysis by including driver behavior with the other inputs (fuel level, consumption rate, external factors). Moreover, integration with external systems allows the system to query outside data sources or receive pushes from them when relevant external events occur or to continually monitor them (e.g. weather and traffic) for route and fuel relevant information and to do so in real time. A further advantage is driver preference learning for setting thresholds and making recommendations.

Aspects of the invention can be implemented in numerous ways, including as a system, a device/apparatus, a method, or a computer readable medium. Several embodiments of the invention are discussed below.

As a method of intelligent fuel monitoring and dynamic routing, an embodiment of the invention includes the operations of: receive input from local sensors as to vehicle status (fuel level, vehicle location, etc.); retrieve data regarding fuel stop locations and environmental data that affects driving routes (e.g., weather/traffic)—the order could be reversed here—the external inputs could trigger the system to check the fuel level. For example, there is bad weather ahead, check the fuel gauge and make sure we have at least ¾ tank); consider any user inputs as to preferences or learned driver behavior related to fueling and routes; process the data in conjunction with current routing information; determine an optimal route; output the results.

The method is performed on a physical device(s), namely a computing device having a memory, an optional display device, input device(s) including sensors, and a processor unit. The method further includes processing the information and storing it on at least one computer-accessible storage device. The method receives information from a real world physical system, namely one or more sensors monitoring one or more of the vehicle status (fuel level, speed, etc.) and location (e.g., GPS), and local or external environment (weather, traffic, fuel prices, fuel stop locations), processes and transforms this data into an optimal route, and outputs this information to the driver.

Embodiments of the methods of the present invention may be implemented as a computer program product with a computer-readable medium having code thereon.

As a system, an embodiment of the invention includes a computing device, such as a computer system or on-board processing system. The computer system comprises, for example, memory, an optional display device, input devices/sensors, output devices, communication devices, and a processor unit and may further be connected to a local or remote database or data source(s). The processor unit operates to receive input from the sensors, external sources, and a user, process this information, and output/display results. The system may include one or more input or sensor devices (e.g., sensors for speed, location/GPS, fuel level, user input), a communication device to access locally stored or remote information such as mapping information, fuel stop locations, routing data/destination/schedule/time, weather, road and traffic conditions; and a computer system coupled to the one or more input or sensor devices, communication device, the computer system having a memory, a processor, wherein the processor is programmed to implement the steps of the invention and output the results.

As a computer readable medium containing program instructions for intelligent monitoring and dynamic routing, an embodiment of the invention includes: computer readable code devices for implementing the steps of the invention.

The invention includes a number of software components, such as an input/sensor reading; communications interfaces; processing modules; tracking module, and an output module, that are embodied upon a computer readable medium.

In an embodiment, the intelligent fuel monitoring and dynamic routing system uses sensors to monitor, for example, one or more of fuel level, vehicle speed, vehicle temperature, outside temperature, and vehicle location. The data retrieved regarding fuel stop locations includes, for example, one or more of fuel price, goods and services offered, hours of operation, and location. The environmental data retrieved that affects a current driving route and at least one alternate driving route includes for example one or more of current weather conditions for the current route, forecasted weather conditions for the current route, traffic for the current route, speed limits for the current route, tolls for the current route, current weather conditions for at least one alternate route, forecasted weather conditions for at least one alternate route, traffic for at least one alternate route, speed limits for at least one alternate route, tolls for at least one alternate route.

User inputs to the system include, for example, user preferences of one or more preferences for minimum fuel level, minimum vehicle speed, maximum vehicle speed, speed limits for routes, toll for routes, vehicle temperature, outside temperature, fuel price, goods and services offered at fuel stops, hours of operation of fuel stops, and location of fuel stops. Learned driver behavior that affects driving routes includes for example one or more of minimum fuel level, minimum vehicle speed, maximum vehicle speed, goods and services offered at fuel stops.

The current routing information can be stored locally in memory or retrieved from external sources/database. It may include a pre-trip route or the current route after the system has proposed an alternate route that the driver has accepted.

Processing all of the data in conjunction with the current routing information may be done by applying a weighted determination system to the data or other known optimization routines.

The optimal route may be output to a display or other output device and also may be saved to memory or transmitted via a communication means to a portable device, remote device, central station, or the like.

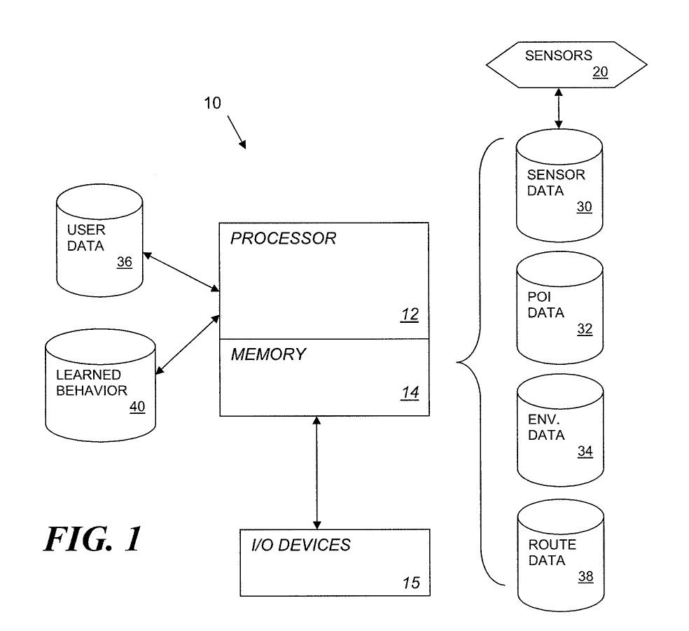

FIG. 1 shows base vehicle base telematics system 10, including onboard processing, sensor and user inputs and connectivity to remote data sources in which methods in accordance with aspects of the invention may be implemented. The system 10 includes a processor 12, a memory 14, and an input/output (I/O) devices 15, all of which are connected to communicate over a set of one or more system buses or other type of interconnections. The system 10 further includes one or more sensor inputs that may be coupled to the onboard processor which receive data from sensors 20. Various components of the system may be local or remote as known in the art. A communication interface is also included for local or remote communications with the system.

The system 10 may be adapted for use in any of a number of monitoring applications, including, e.g., passenger vehicles, commercial vehicles, fleets, and tractor-trailers. The minimization of fuel usage reduces costs and also the amount of exhaust emitted. Secondly aspects of the system and method of the present invention allow for reducing hours of service (HOS) for commercial drivers through smart routing, and increase the quality of service to customers by meeting scheduled delivery times or delivery time windows. Accordingly, drivers will be able to make more intelligent fuel purchases at the optimal time. They will avoid too frequent fueling and/or the risk of running out of fuel. More generally, the system 10 can be used in any application that can benefit from the improved fuel monitoring capabilities provided by aspects of the present invention.

The term “processor” as used herein is intended to include a microprocessor, central processing unit (CPU), microcontroller, digital signal processor (DSP) or any other data processing element that may be utilized in a given on-board processing system. In addition, it should be noted that the memory may represent an electronic memory, an optical or magnetic disk-based memory, a tape-based memory, as well as combinations or portions of these and other types of storage devices.

Software programming code which embodies aspects of the present invention is typically stored in permanent storage of some type, such as the permanent storage of the on-board processing system. The software programming code may be embodied on any of a variety of known media for use with a data processing system, such as a diskette, or hard drive, USB storage media, or CD-ROM. The techniques and methods for embodying software program code on physical media and/or distributing software code via networks are well known and will not be further discussed herein.

An exemplary system for implementing aspects of the invention includes an on-board processing system for a vehicle. In a basic configuration, on-board processing system 10 is a computing device permanently or removeably attached to the vehicle and also includes a mobile computing device. Computing device typically includes at least one processing unit 12 and system memory 14. Depending on the exact configuration and type of computing device, system memory may be volatile (such as RAM), non-volatile (such as ROM, flash memory, and the like) or some combination of the two. System memory typically includes operating system, one or more applications, and may include program data. Computing device may also have additional features or functionality. For example, computing device may also include additional data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules or other data. System memory, removable storage and non-removable storage are all examples of computer storage media. Any such computer storage media may be part of device. Computing device may also have input device(s) 15 such as a keyboard, mouse, pen, voice input device, touch input device, sensors, receivers, etc. Output device(s) 15 such as a display, speakers, printer, transmitters, etc. may also be included. Computing device also contains communication connection(s) that allow the device to communicate with other computing devices, such as wirelessly. By way of example, and not limitation, communication connection(s) may include broadband, satellite, RF, infrared, cellular, and other wireless means.

In one embodiment the intelligent fuel monitoring and dynamic routing system for vehicles, includes one or more sensor devices monitoring a vehicle status; and a processing system coupled to the one or more sensor devices, the processing system having a memory and a processor, wherein the processor is programmed (see FIGS. 1 -2) to: (a) receive 100 a plurality of data 105 comprising: (i) vehicle status data 30; (ii) points of interest data 32; (iii) environmental data 34; (iv) user data 36; (v) route data 38; (b) learn driver behavior 110 from the plurality of data that influences selection of driving routes; (c) process the plurality of data 112 for a current route; (d) determine an optimal route 114 based on the plurality of data processed for the current route and the learned driver behavior 40; and (e) output 116 the optimal route.

In a particular embodiment, vehicle status data include one or more of fuel level data, vehicle fluid level data, vehicle speed data, vehicle temperature data, outside temperature data, and vehicle location data. The one or more sensor devices monitor the vehicle for the vehicle status data.

In a particular embodiment, points of interest data include information about intermediate stopping points including one or more of locations for points of interest, hours of operation at the points of interest, prices for goods and services at the points of interest, goods and services offered at the points of interest, and fuel prices at the points of interest.

In a particular embodiment, environmental data include environmental data that affects a current driving route and at least one alternate driving route comprising one or more of current weather conditions for the current route, forecasted weather conditions for the current route, traffic for the current route, speed limits for the current route, tolls for the current route, current weather conditions for at least one alternate route, forecasted weather conditions for at least one alternate route, traffic for at least one alternate route, speed limits for at least one alternate route, tolls for at least one alternate route.

In a particular embodiment, user data include user inputs of preferences and thresholds comprising one or more inputs for minimum fuel level, minimum vehicle speed, maximum vehicle speed, speed limits for routes, toll for routes, vehicle temperature, outside temperature, fuel price, goods and services offered at points of interest, hours of operation of points of interest, and location of points of interest.

In a particular embodiment, route data include one or more driving routes including a current route and at least one alternate route.

In a particular embodiment, the memory of the processing device has stored locally thereon current routing information. Determining the optimal route comprises applying a weighted determination system to the plurality of data. An optional display may be included for displaying the optimal route. A communication device is used for receiving one or more of the plurality of data from one or more remote sources 105 communicating wirelessly with the processing system. The remote source may include a backend system where the communication uses pushing, pulling, periodic, or continuous data transmission.

In a particular embodiment, as a method of intelligent fuel monitoring and dynamic routing for vehicles, the method includes: (a) receiving and storing a plurality of data comprising: (i) vehicle status data; (ii) location data; (iii) environmental data; (iv) user data; (v) route data; (b) learning by a processing device driver behavior from the plurality of data that influences selection of driving routes; (c) processing by the processing device the plurality of data for a current route; (d) determining by the processing device an optimal route based on the plurality of data processed for the current route and the learned driver behavior; and (e) outputting to an output device the optimal route.

In a particular embodiment, as a computer readable medium for intelligent fuel monitoring and dynamic routing for vehicles, the media includes code for: (a) receiving and storing a plurality of data comprising: (i) vehicle status data; (ii) location data; (iii) environmental data; (iv) user data; (v) route data; (b) learning by a processing device driver behavior from the plurality of data that influences selection of driving routes; (c) processing by the processing device the plurality of data for a current route; (d) determining by the processing device an optimal route based on the plurality of data processed for the current route and the learned driver behavior; and (e) outputting to an output device the optimal route.

Computer program code for carrying out operations of aspects of the invention described above may be written in a high-level programming language, such as JAVA, C or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller. A code in which a program of embodiments of the present invention is described can be included as a firmware in a RAM, a ROM and a flash memory. Otherwise, the code can be stored in a tangible computer-readable storage medium such as a magnetic tape, a flexible disc, a hard disc, a compact disc, a photo-magnetic disc, a DVD. Aspects of the present invention can be configured for use in a computer or an information processing apparatus which includes a memory, such as a central processing unit (CPU), a RAM and a ROM as well as a storage medium such as a hard disc.

The “step-by-step process” for performing the claimed functions herein is a specific algorithm, and may be shown as a mathematical formula, in the text of the specification as prose, and/or in a flow chart. The instructions of the software program create a special purpose machine for carrying out the particular algorithm.

A general purpose computer, or microprocessor, may be programmed to carry out the algorithm/steps of embodiments of the present invention creating a new machine. The general purpose computer becomes a special purpose computer once it is programmed to perform particular functions pursuant to instructions from program software of the embodiments of the present invention. The instructions of the software program that carry out the algorithm/steps electrically change the general purpose computer by creating electrical paths within the device. These electrical paths create a special purpose machine for carrying out the particular algorithm/steps.

Unless specifically stated otherwise as apparent from the discussion, it is appreciated that throughout the description, discussions utilizing terms such as “processing” or “computing” or “calculating” or “determining” or “displaying” or the like, refer to the action and processes of a computer system or processor, or similar electronic computing device, that manipulates and transforms data represented as physical (electronic) quantities within the computer system's registers and memories into other data similarly represented as physical quantities within the computer system memories or registers or other such information storage, transmission or display devices.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. An intelligent fuel monitoring and dynamic routing system for vehicles, the system comprising:
one or more sensor devices monitoring a vehicle status; and
a processing system coupled to the one or more sensor devices, the processing system having a memory and a processor, wherein the processor is programmed to:
(a) receive a plurality of data comprising:
(i) vehicle status data;
(ii) points of interest data;
(iii) environmental data;
(iv) user data;
(v) route data;
(b) learn driver behavior from the plurality of data that influences selection of driving routes;
(c) process the plurality of data for a current route;
(d) determine an optimal route based on the plurality of data processed for the current route and the learned driver behavior; and
(e) output the optimal route.

2. The intelligent fuel monitoring and dynamic routing system of claim 1 wherein vehicle status data comprise one or more of fuel level data, vehicle fluid level data, vehicle speed data, vehicle temperature data, outside temperature data, and vehicle location data.

3. The intelligent fuel monitoring and dynamic routing system of claim 2 wherein the one or more sensor devices monitor the vehicle for the vehicle status data.

4. The intelligent fuel monitoring and dynamic routing system of claim 1 wherein points of interest data comprises information about intermediate stopping points including one or more of locations for points of interest, hours of operation at the points of interest, prices for goods and services at the points of interest, goods and services offered at the points of interest, and fuel prices at the points of interest.

5. The intelligent fuel monitoring and dynamic routing system of claim 1 wherein environmental data comprises environmental data that affects a current driving route and at least one alternate driving route comprising one or more of current weather conditions for the current route, forecasted weather conditions for the current route, traffic for the current route, speed limits for the current route, tolls for the current route, current weather conditions for at least one alternate route, forecasted weather conditions for at least one alternate route, traffic for at least one alternate route, speed limits for at least one alternate route, tolls for at least one alternate route.

6. The intelligent fuel monitoring and dynamic routing system of claim 1 wherein user data comprises user inputs of preferences and thresholds comprising one or more inputs for minimum fuel level, minimum vehicle speed, maximum vehicle speed, speed limits for routes, toll for routes, vehicle temperature, outside temperature, fuel price, goods and services offered at points of interest, hours of operation of points of interest, and location of points of interest.

7. The intelligent fuel monitoring and dynamic routing system of claim 1 wherein route data comprises one or more driving routes including a current route and at least one alternate route.

8. The intelligent fuel monitoring and dynamic routing system of claim 1 wherein learned driver behavior from the plurality of data that influences selection of driving routes comprises one or more driver behaviors learned from analyzing a history of the plurality of data.

9. The intelligent fuel monitoring and dynamic routing system of claim 1 wherein the memory of the processing device has stored locally thereon current routing information.

10. The intelligent fuel monitoring and dynamic routing system of claim 1 wherein determining the optimal route comprises applying a weighted determination system to the plurality of data.

11. The intelligent fuel monitoring and dynamic routing system of claim 1 further comprising a display for displaying the optimal route.

12. The intelligent fuel monitoring and dynamic routing system of claim 1 further comprising a communication device for receiving one or more of the plurality of data from one or more remote sources communicating wirelessly with the processing system.

13. The intelligent fuel monitoring and dynamic routing system of claim 12 wherein the remote source comprises a backend system wherein communication comprises pushing, pulling, periodic, or continuous data transmission.

14. The intelligent fuel monitoring and dynamic routing system of claim 12 wherein route data comprises road maps for navigation.

15. A method of intelligent fuel monitoring and dynamic routing for vehicles, the method comprising:
(a) receiving and storing a plurality of data comprising:
(i) vehicle status data;
(ii) location data;
(iii) environmental data;
(iv) user data;
(v) route data;
(b) learning by a processing device driver behavior from the plurality of data that influences selection of driving routes;
(c) processing by the processing device the plurality of data for a current route;
(d) determining by the processing device an optimal route based on the plurality of data processed for the current route and the learned driver behavior; and
(e) outputting to an output device the optimal route.

16. The method intelligent fuel monitoring and dynamic routing for vehicles of claim 15 wherein route data comprises one or more driving routes including a current route and at least one alternate route.

17. The method intelligent fuel monitoring and dynamic routing for vehicles of claim 15 wherein learned driver behavior from the plurality of data that influences selection of driving routes comprises one or more driver behaviors learned from analyzing a history of the plurality of data.

18. The method intelligent fuel monitoring and dynamic routing for vehicles of claim 15 wherein determining the optimal route comprises applying a weighted determination system to the plurality of data.

19. The method intelligent fuel monitoring and dynamic routing for vehicles of claim 15 further comprising communicating wirelessly with the processing system via a communication device for receiving one or more of the plurality of data from one or more remote sources.

20. A computer readable medium for intelligent fuel monitoring and dynamic routing for vehicles, including code devices for:
(a) receiving and storing a plurality of data comprising:
(i) vehicle status data;
(ii) location data;
(iii) environmental data;
(iv) user data;
(v) route data;
(b) learning by a processing device driver behavior from the plurality of data that influences selection of driving routes;
(c) processing by the processing device the plurality of data for a current route;
(d) determining by the processing device an optimal route based on the plurality of data processed for the current route and the learned driver behavior; and
(e) outputting to an output device the optimal route.
